(19) United States
(12) Patent Application Publication
(10) Pub. No.: US 2010/0265297 A1
(43) Pub. Date: Oct. 21, 2010

(54) Inkjet head

(75) Inventors: Yoon-Sok Park, Suwon-si (KR); Jae-Woo Joung, Suwon-si (KR); Young-Seuck Yoo, Seoul (KR); Chang-Sung Park, Suwon-si (KR); Ju-Hwan Yang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,365

(22) Filed: Dec. 17, 2009

(30) Foreign Application Priority Data
Apr. 15, 2009 (KR) 10-2009-0032823

(51) Int. Cl. B41J 2/14

(52) U.S. Cl. 347/47

(57) ABSTRACT

An inkjet head is disclosed. In accordance with an embodiment of the present invention, the ink-jet head that prevents a nozzle from being blocked by a residual ink droplet formed on the nozzle can include a head body having the nozzle formed on one surface thereof and an actuator, which provides pressure to the inside of the head body. Here, a transfer groove is formed on one surface of the head body, in which the transfer groove is separated from the nozzle to provide a path through which the residual ink droplet moves. Thus, the inkjet head can prevent the nozzle from being blocked by a residual ink droplet formed on the nozzle by use of the transfer groove, which provides a path for a residual ink droplet formed on the nozzle to escape.

### CROSS-REFERENCE TO RELATED APPLICATIONS

This application claims the benefit of Korean Patent Application No. 10-2009-0032823, filed with the Korean Intellectual Property Office on Apr. 15, 2009, the disclosure of which is incorporated herein by reference in its entirety.

### BACKGROUND

1. Technical Field

The present invention relates to an inkjet head.

2. Description of the Related Art

An ink-jet head is an apparatus for ejecting a droplet of ink through a nozzle by converting an electric signal to a physical force. The ink-jet head is manufactured by forming different components, such as a chamber, a restrictor, a nozzle and a damper, on several layers and laminating these layers with one another. Not only is the ink-jet technology used for industrial applications, for example, printing on conventional paper or fabric in the graphic inkjet industry, but it is also used for manufacturing electronic components, such as a printed circuit board (PCB) or an LCD panel.

The inkjet printing head is advantageous for a higher printing speed since it can perform printing by ejecting ink droplets in a higher frequency. However, as the printing speed becomes faster, it may cause instabilities that arise when ink is ejected. One of the instabilities is nozzle wetting.

Particularly, if an operation frequency is changed, it may cause an unstable meniscus movement, and an ink droplet may form on a lower surface of a nozzle of an inkjet head. As the amount of ink droplet accumulated at the nozzle becomes excessive, the ink droplet may eventually clog the entrance of the nozzle, disabling further ejection of the ink droplet.

### SUMMARY

The present invention provides an inkjet head that can prevent a nozzle from being clogged by a residual ink droplet formed in the nozzle.

An aspect of the present invention provides an inkjet head that prevents a nozzle from being clogged by a residual ink droplet formed on the nozzle. In accordance with an embodiment of the present invention, the inkjet head includes a head body having the nozzle formed on one surface thereof and an actuator, which provides pressure to the inside of the head body. Here, a transfer groove is formed on one surface of the head body, in which the transfer groove is separated from the nozzle to provide a path through which the residual ink droplet moves.

The transfer groove can include a first side, which is adjacent to the nozzle, and a second side, which is extended in an opposite direction of the nozzle from the first side. Here, the transfer groove can become gradually wider from the first side to the second side.

There can be a plurality of transfer grooves, and the plurality of transfer grooves can be disposed in a radial direction from the nozzle.

There can be a plurality of nozzles, and the transfer groove can be formed for each of the plurality of nozzles.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of an inkjet head.

FIG. 2 is a bottom view of an inkjet head in accordance with an embodiment of the present invention.

FIG. 3 is a bottom view of an inkjet head in accordance with another embodiment of the present invention.

FIG. 4 is a bottom view of an inkjet head in accordance with yet another embodiment of the present invention.

FIG. 5 is a bottom view of an inkjet head in accordance with still another embodiment of the present invention.

FIGS. 6A, 6B, 7A, 7B, 8A, and 8B collectively show a process of relieving nozzle clogging in an inkjet head in accordance with an embodiment of the present invention.

### DETAILED DESCRIPTION

As the invention allows for various changes and numerous embodiments, particular embodiments will be illustrated in the drawings and described in detail in the written description. However, this is not intended to limit the present invention to a particular mode of practice, and it is to be appreciated that all changes, equivalents and substitutes that do not depart from the spirit and technical scope of the present invention are encompassed in the present invention.

An inkjet head according to certain embodiments of the present invention will be described below in more detail with reference to the accompanying drawings. Those components that are the same or are in correspondence are rendered the same reference numeral regardless of the figure number, and redundant descriptions are omitted.

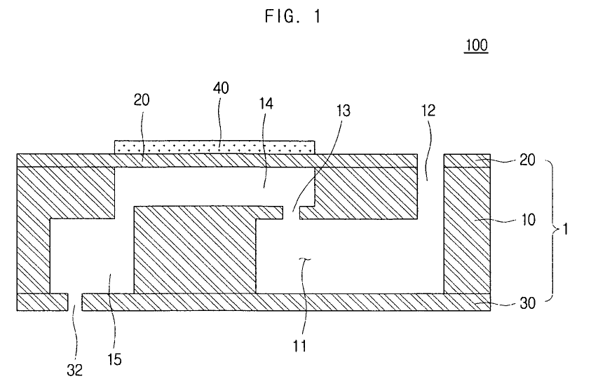

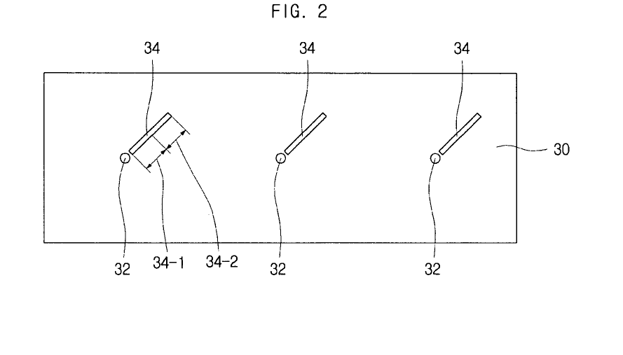

FIG. 1 is a cross-sectional view of an inkjet head, and FIG. 2 is a bottom view of an inkjet head in accordance with an embodiment of the present invention. Illustrated in FIGS. 1 and 2 are an inkjet head 100, a body 1, a center substrate 10, a reservoir 11, an inlet 12, a restrictor 13, a chamber 14, a damper 15, a membrane 20, a nozzle plate 30, a nozzle 32, a transfer groove 34 and an actuator 40.

The chamber 14, which contains ink, is a device for ejecting the ink by moving the contained ink in a direction of the nozzle 32 when pressure is applied by the actuator 40, for example, a piezoelectric body, formed on an upper surface of the membrane 20. A plurality of chambers 14, for example, 128 chambers or 256 chambers, can be disposed in parallel in a single inkjet head 100, and there can be a matching number of actuators 40 to the chambers 14 in order to provide pressure to each of the plurality of chambers 14. Here, the actuators 40 are separated from one another so that adjacent chambers are minimally influenced by the actuators 40.

The reservoir 11 is supplied with ink from the outside through the inlet 12, stores the ink, and provides the ink to the chamber 14 described above.

The restrictor 13 links the reservoir 11 with the chamber 14 and can function as a channel controlling the flow of ink between the reservoir 11 and the chamber 14. The restrictor 13 is formed to have a smaller sectional area than those of the reservoir 11 and the chamber 14 such that the restrictor 13 can control the amount of ink supplied to the chamber 14 from the reservoir 11 when the membrane 20 is vibrated by the actuator 40.

The nozzle 32 is connected to the chamber 14 and ejects the ink supplied from the chamber 14. When the vibration generated by the actuator is supplied to the chamber 12 through a vibrating plate, pressure can be applied to the chamber 14, causing the nozzle 32 to eject the ink.

The damper 15 is interposed between the chamber 14 and the nozzle 32. The damper 15 can concentrate the energy generated by the chamber 14 toward the nozzle 32 and dampen a rapid change in pressure.

An inkjet head constituted by the above-described elements can be formed either by stacking a plurality of substrates made of, for example, silicon or ceramic, or with a single substrate. For the convenience of description, however, a body, excluding an actuator, constituted by a center substrate, a membrane and a nozzle plate will be described.

While, in the present embodiment, a piezoelectric body adhered to an upper surface of the membrane 20 is presented as the actuator 40 for providing pressure to the inside of the head body 1, more specifically, to the chamber 14, it shall be apparent that the present invention is not limited to this particular embodiment, and the configuration of the actuator can be changed, depending on the type of driving an inkjet head, for example, the electrostatic type or bubble jet type.

The center substrate 10 is constituted by the chamber 14, the reservoir 11, the restrictor 13 and the damper 15, which have been described above. The center substrate 10 can be made of a material, such as a silicon wafer, a silicon-on-insulation (SOI) substrate or a ceramic substrate, and the chamber 14 and the reservoir 11 described above can be formed by processing both sides of the center substrate 10 by way of wet etching or dry etching. If the center substrate is formed by stacking a plurality of silicon wafers, as described above, each of the plurality of silicon wafers can be processed first, and then the processed wafers can be coupled to one another to form the center substrate.

The membrane 20 is coupled to an upper surface of the center substrate 10 so as to cover the chamber 14 and can transfer the vibration generated by the actuator 40 to the inside of the chamber 14. The membrane 20 can be made of a thin film silicone substrate, ceramic substrate or glass substrate.

The nozzle plate 30 is coupled to a lower surface of the center substrate 10, and the nozzle 32 is formed in the position corresponding to the damper 15. The nozzle 32 is formed in the shape of a hole penetrating through the nozzle plate 30, and can be formed by wet etching or dry etching that is used for processing the nozzle plate 30. The shape of the nozzle 32 can vary, depending on the design specifications.

The lower surface of the nozzle plate 30 is formed with the transfer groove 34 for providing a path for a residual ink droplet formed on the nozzle 32 to escape. The transfer groove 34 is formed at a close location to the nozzle 32. However, it is preferred that the transfer groove 34 is not in direct contact with the nozzle 32 since the transfer groove 34 may interrupt the normal operation of the nozzle 32. That is, the transfer groove 32 can be formed a slight distance apart from the nozzle 32, as illustrated in FIG. 2. Here, the distance between the transfer groove 34 and the nozzle 32 can be determined by considering the size of ink droplets being ejected and the size of residual ink droplets being removed.

The transfer groove 34 can be formed while the nozzle 32 is processed in the nozzle plate 30, or through another, separate process. As illustrated in FIG. 2, the transfer groove 34 can be divided into a first side 34-1, which is adjacent to the nozzle 32, and a second side 34-2, which is extended in an opposite direction of the nozzle 32 from the first side 34-1. That is, the transfer groove 34 can be extended from the position adjacent to the nozzle 32 in an opposite direction of the nozzle 32, and can be formed in the shape of a long, narrow slit.

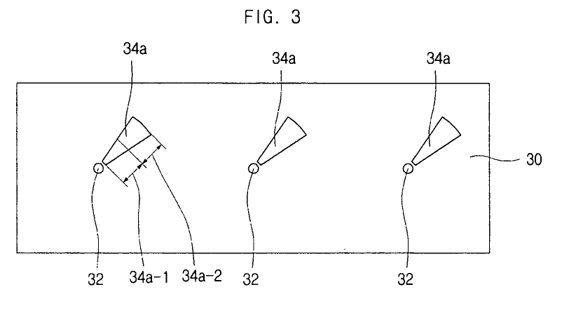

Also, as illustrated in FIG. 3, a transfer groove 34a can be shaped such that the transfer groove 34a becomes wider from a first side 34a-1 to a second side 34a-2. If the transfer groove 34a becomes wider from the first side 34a-1, which is adjacent to the nozzle 32, to the second side 34a-2, which is extended in the opposite direction from the nozzle 32, resistance against the movement of a residual ink droplet from the first side 34a-1 to the second side 34a-2 can be gradually reduced, so that the residual ink droplet travelling along the groove 34 can be prevented from flowing back to the nozzle 32. It is also possible to lower the chance of the residual ink droplet flowing back to the nozzle 32 by gradually increasing the depth of the groove from the first sides 34-1 and 34a-1 to the second sides 34-2 and 34a-2.

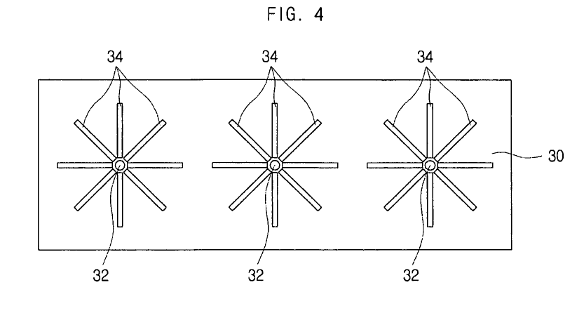

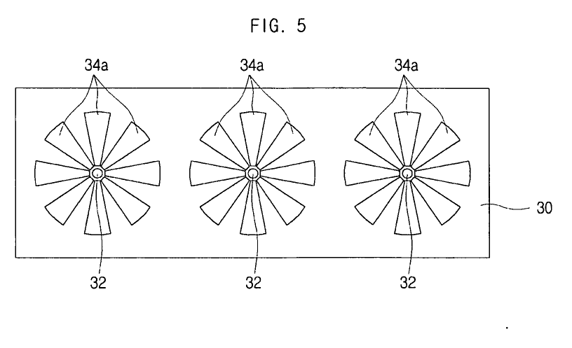

As illustrated in FIGS. 2 to 5, the transfer grooves 34 and 34a can be provided for each of the nozzles 32 to prevent the nozzles 32 from being clogged. Also, as illustrated in FIGS. 4 and 5, a plurality of transfer grooves 34 can be formed for a single nozzle 32 so as to diversify the escaping routes of the residual ink droplet. Here, each of the transfer grooves 34 and 34a can be disposed in a radial direction from the nozzle 32, as illustrated in FIGS. 4 and 5.

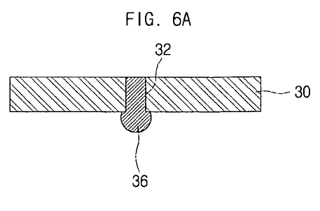

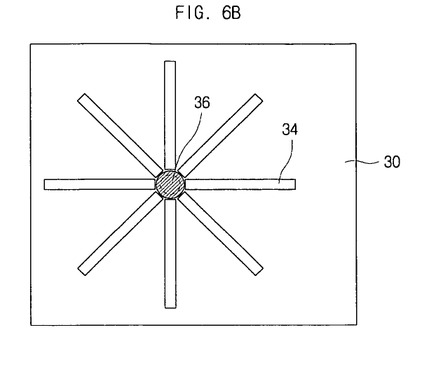

Hitherto, the structure of an inkjet head in accordance with an embodiment of the present invention has been described. Hereinafter, with reference to FIGS. 6 to 8, a method of preventing the clogging of a nozzle by a residual ink droplet formed on the nozzle in an inkjet head in accordance with an embodiment of the present invention will be described. FIGS. 6A, 7A and 8A are cross-sectional views of a nozzle plate 30, and FIGS. 6B, 7B and 8B are bottom views of the nozzle plate 30.

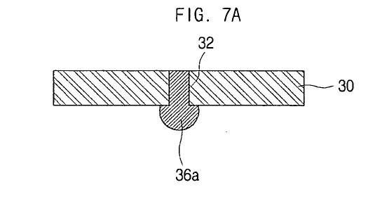

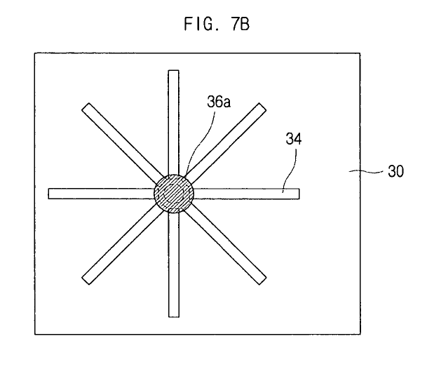

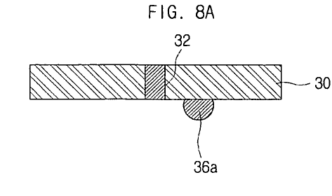

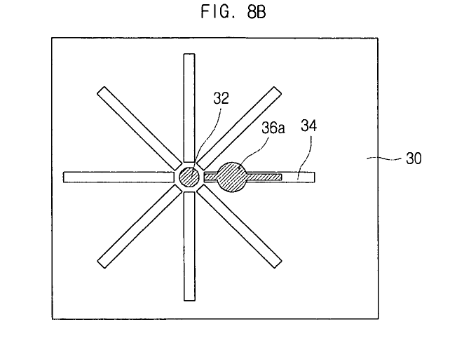

If the operation frequency of an inkjet head, more specifically, of a unit nozzle 32, is changed, it may cause an unstable meniscus movement so that an ink droplet 36 may form on a lower surface of the inkjet head at which the nozzle 32 is formed, as illustrated in FIGS. 6A and 6B. While the amount of the ink droplet 36 accumulated at the nozzle becomes excessive, the size of a residual ink droplet 36a is gradually increased, as illustrated in FIGS. 7A and 7B. As the size of the residual ink droplet 36a keeps growing, it can reach the transfer groove 32 that is adjacent to the nozzle 32. Then, the residual ink droplet 36a travels from the nozzle 32 to the transfer groove 34, as illustrated in FIGS. 8A and 8B, and thus the residual ink droplet 36a, which has been clogging the nozzle 32, can be removed from the nozzle 32.

While the spirit of the present invention has been described in detail with reference to particular embodiments, the embodiments are for illustrative purposes only and shall not limit the present invention. It is to be appreciated that those skilled in the art can change or modify the embodiments without departing from the scope and spirit of the present invention.

As such, many embodiments other than those set forth above can be found in the appended claims.

What is claimed is:

1. An inkjet head configured to prevent a nozzle from being clogged by a residual ink droplet formed on the nozzle, the inkjet head comprising:
a head body having the nozzle formed on one surface thereof; and
an actuator configured to provide pressure to the inside of the head body,
wherein a transfer groove is formed on one surface of the head body, the transfer groove being separated from the nozzle to provide a path through which the residual ink droplet moves.

2. The inkjet head of claim 1 wherein the transfer groove comprises:
a first side being adjacent to the nozzle; and
a second side being extended in an opposite direction of the nozzle from the first side.

3. The inkjet head of claim 2 wherein the transfer groove becomes gradually wider from the first side to the second side.

4. The inkjet head of claim 1 wherein there are a plurality of transfer grooves.

5. The inkjet head of claim 4 wherein the plurality of transfer grooves are disposed in a radial direction from the nozzle.

6. The inkjet head of claim 1 wherein there are a plurality of nozzles, and the transfer groove is formed for each of the plurality of nozzles.
